(19) United States
(12) Patent Application Publication
(10) Pub. No.: US 2010/0084125 A1
(43) Pub. Date: Apr. 8, 2010

(54) MICROCLIMATE CONTROL SYSTEM

(76) Inventors: Albert M. Goldstein, Farmington Hills, MI (US); Theodore W. Nickel, Bloomfield Hills, MI (US); Michael G. Paige, Bloomfield Hills, MI (US); Vincent F. Quaglia, Sterling Heights, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/543,345

(22) Filed: Aug. 18, 2009

Related U.S. Application Data
(60) Provisional application No. 61/089,753, filed on Aug. 18, 2008.

(51) Int. Cl. G05D 23/00; B23P 11/00; F25D 23/00

(52) U.S. Cl. 165/287; 29/428; 62/259.3; 62/3.5; 165/58

(57) ABSTRACT

A heating/cooling garment is provided that comprises a microclimate system, as well as methods of manufacturing and using same.

### RELATED APPLICATIONS

The present application claims priority to U.S. Provisional Application No. 61/089,753 filed on Aug. 18, 2008, the contents of which are incorporated herein in their entirety.

### BACKGROUND

Harsh environmental climates can have a detrimental impact upon the health and wellbeing of humans and other mammals. In extremely cold climates such as Siberia, for example, people can suffer from hypothermia and other ailments. In extremely warm environments such as the deserts in the Middle East, people can suffer from heat exhaustion and other ailments. For example, soldiers who are burdened with heavy equipment are often exposed to such harsh environmental climates. Also, when the soldiers are so exposed, they are often in remote locations without access to power sources or a method or mechanism to artificially regulate core body temperature.

Additionally, persons may suffer from medical conditions that require temperature adjustments relative to the ambient air. For example, a person suffering from shock may require the application of heat from an external source for his or her medical benefit. Similarly, a burn victim or heat-exhaustion patient may require the application of a cooling or heat-removal system for his or her medical benefit.

As such, a portable microclimate system in communication with a garment (such as a vest or a blanket) to regulate a person's core body temperature is desired. An exemplary desired microclimate system may be self-regulating, controlled by the person wearing the garment, and/or controlled remotely by persons and/or systems receiving sensed data about the person wearing the garment and/or his or her environment. An exemplary desired microclimate system may be small and lightweight. An exemplary desired microclimate system may regulate the wearer's core body temperature quickly, efficiently and thoroughly.

### BRIEF DESCRIPTION OF THE FIGURES

The claims are not limited to the illustrated examples or drawings related thereto. Although the drawings represent particular examples, the drawings are not necessarily to scale and certain features may be exaggerated to better illustrate and explain an innovative aspect. Further, the examples described herein are not intended to be exhaustive or otherwise limiting or restricting to the precise form and configuration shown in the drawings and disclosed in the following detailed description.

FIG. 1 depicts an exemplary microclimate control system in communication with a heating/cooling vest.

FIG. 2 is a schematic of an exemplary microclimate control system.

FIG. 3 is a flow diagram of an exemplary cooling application.

FIG. 4 is an exploded view of an exemplary chiller/heater assembly.

FIG. 5 is a perspective view of the exemplary chiller/heater assembly of FIG. 4.

FIG. 6 is a side view of the exemplary chiller/heater assembly of FIG. 4 held together by a clip assembly.

FIG. 7 is a side view of an exemplary radiator assembly in-situ.

FIG. 8 is a perspective view of an exemplary radiator panel.

FIG. 9 is a schematic of an exemplary microclimate control system.

### DETAILED DESCRIPTION

Reference in the specification to “an exemplary illustration”, and “example” or similar language means that a particular feature, structure, or characteristic described in connection with the exemplary approach is included in at least one illustration. The appearances of the phrase “in an illustration” or similar type language in various places in the specification are not necessarily all referring to the same illustration or example.

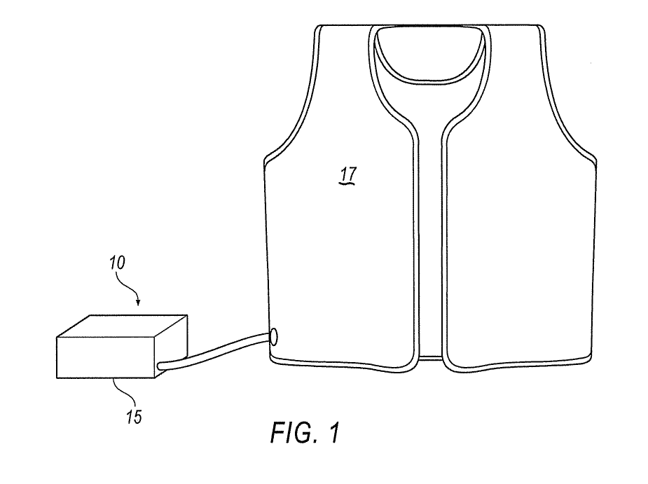

Referring to FIG. 1, microclimate control system 10 comprises a case 15 in fluid communication with a heating/cooling garment 17. Although a vest is depicted as garment 17, it is contemplated that any other garment could be in fluid communication with a microclimate control system 10, such as a jacket, a blanket, a body wrap, etc.

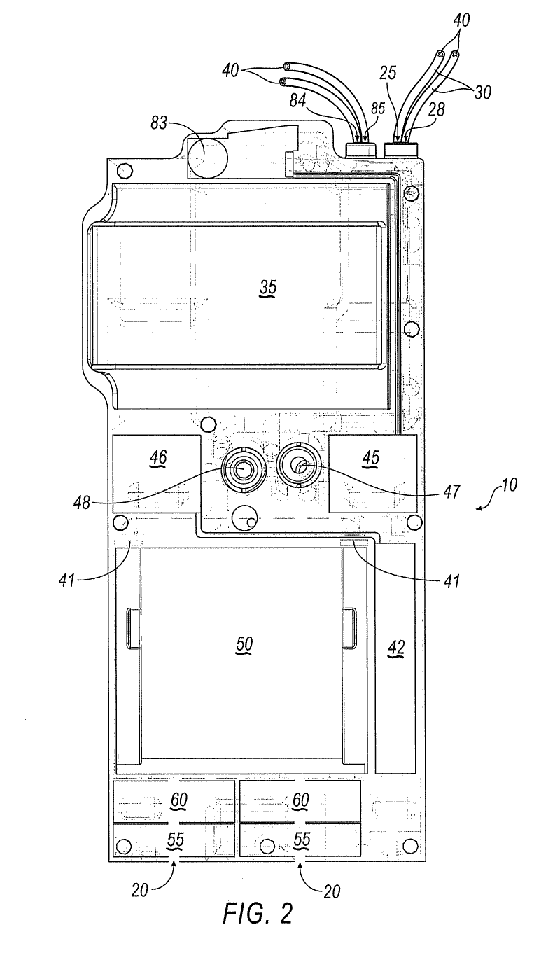

Referring to FIG. 2, case 15 is a laser-sintered nylon box. It is contemplated that case 15 can be made of one or more other well known high-strength and lightweight materials, such as thermosetting plastics or light-weight metals, and manufactured using any known manufacturing method. The material or materials comprising case 15 may have insulating properties to prevent parasitic thermal transfer from the components of case 15 to ambient air. Case 15 may include at least one thermally conductive polymer. In examples where case 15 is made of multiple materials or materials having a variance in concentration of thermally conductive ingredients, the material nearer to the end on the outermost surface of case 15 may be more conductive than the material or materials nearer to the internal structures of case 15, which may be more insulating. The material or materials comprising case 15 may also be of a strength sufficient to provide protection to components of the case if subjected to rough handling or dropping on a hard surface.

In the example depicted in FIG. 2, case 15 is laser sintered such that a plurality of bores (such as bore 26) and chambers are integrally formed with case 15 to minimize or eliminate the need for tubing to carry a gas or fluid heat transfer medium 40 within the case 15. In FIG. 2, no tubing is necessary for the internal components to be in fluid communication with one another; components are designed to fit together with integrally-formed bores in case 15 for efficient fluid communication and ease of assembly. In the example depicted in FIG. 2, component location receptacles as well as mounts for pumps and liquid seals are also integrally formed with case 15 in the laser-sintering process. It is contemplated that such receptacles and mounts need not be integrally formed, so long as they are readily accessible for ease of modular assembly for purposes of repair and maintenance.

Case 15 may be sized and shaped to fit within or to otherwise mount to the heating/cooling garment 17 or another garment or device worn by the user. Case 15 may be sized and shaped so as not to interfere with the mobility of the user. In one example, the case 15 is substantially rectangular in shape and is less than about three (3) inches by about five (5) inches by about seven (7) inches, or about eight (8) centimeters by about thirteen (13) centimeters by about eighteen (18) centimeters. Case 15 may be of a smaller or larger size, and shaped ergonomically for the comfort of the user. Case 15, with all its contents, may weigh less than about fifteen (15) lbs (about seven (7) kilograms), less than about ten (10) lbs (about five (5) kilograms), or less than about five (5) lbs (about two (2) kilograms). In the depicted exemplary embodiment, case 15 includes several components of microclimate control system 10, including a chiller/heater assembly 35 and a radiator assembly 50, (each to be described in more detail below), but it need not. For example, a first case 15 may contain a radiator assembly 50 and a second case 15 may contain a chiller/heater assembly 35, so long as both cases are in selective fluid communication with one another. Any number of cases 15 may be used, depending upon what is appropriate for the particular application.

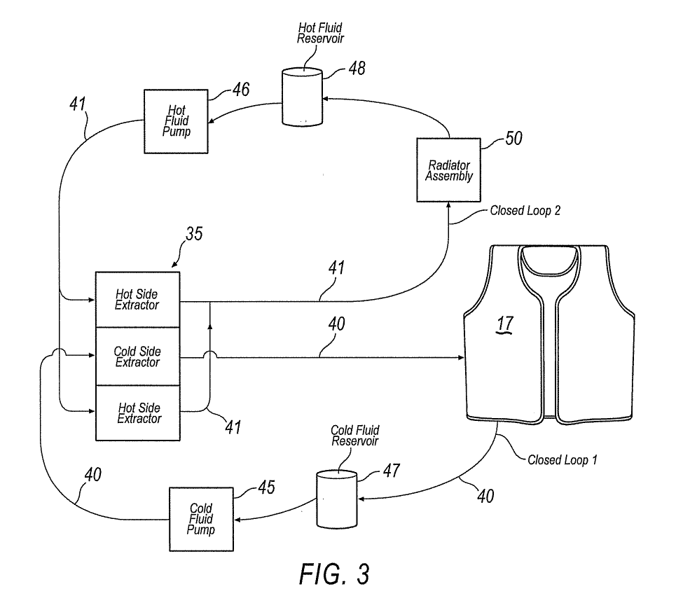

The illustrative microclimate control system 10 depicted in FIG. 2 includes two closed-loop fluidic heating/cooling systems cycling through a number of components. FIG. 3 discloses an exemplary flow of heat transfer media 40 and 41 in both closed loops in an exemplary cooling application.

In the exemplary cooling application, garment 17 is designed for a high flow rate of heat transfer medium 40. In this instance, cooled heat transfer medium 40 flows into the garment 17 in a closed loop system via outlet 25 and through tubing 30. In particular, the heat transfer medium 40 flows away from case 15 through outlet 25. While circulating through the garment 17, the heat transfer medium 40 absorbs heat from the user's body temperature. Then, the heated heat transfer medium 40 exits the garment 17 through tubing 30 and re-enters case 15 via inlet 28.

After leaving garment 17 and returning to case 15 by way of inlet 28, heat transfer medium 40 is directed to cold fluid reservoir 47. From cold fluid reservoir 47, heat transfer medium 40 is pumped through cold fluid pump 45 into a cold side extractor portion of chiller/heater assembly 35. In particular, heat transfer medium 40 flows through a cold-side extractor portion of the chiller/heater assembly 35, where heat is transferred from heat transfer medium 40 to heat transfer medium 41, thereby cooling heat transfer medium 40.

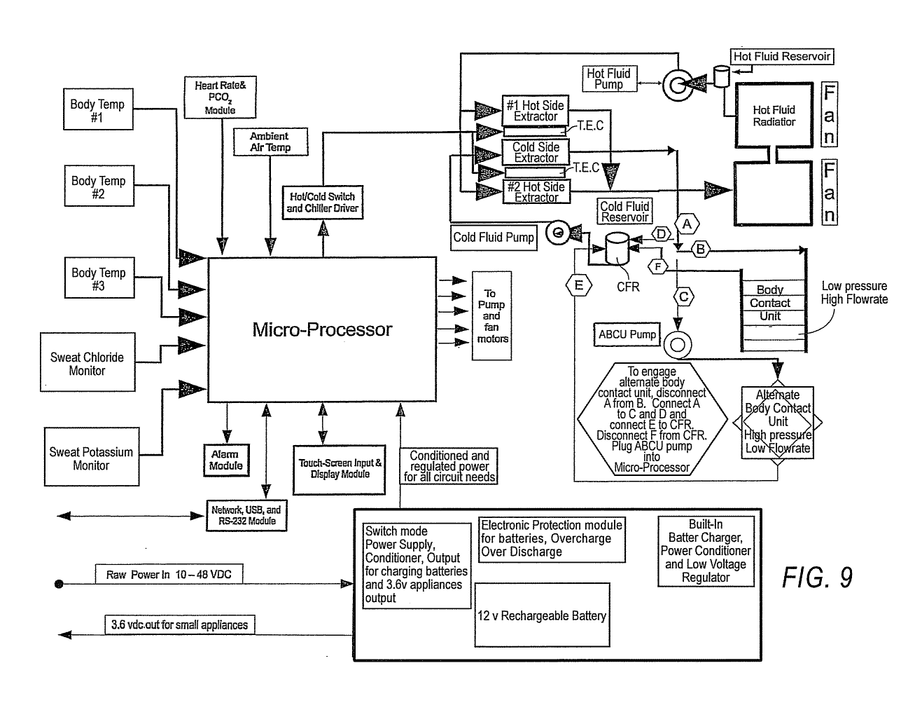

In another cooling example involving a garment 17 that is designed for a low flow rate, a rate adjustment pump 83 (also depicted as ABCU pump in FIG. 9) may be introduced into closed loop 1 before heat transfer medium 40 is pumped into garment 17. Such an arrangement permits the heat transfer medium 40 to move more quickly through the cold side extractor portions of chiller/heater assembly 35 than through the garment 17. Such a system may be desirable where a low flow rate garment 17 is used in a system 10 that employs a chiller/heater assembly 35 which uses thermoelectric coolers (TECs), which have a hot side and a cold side, between the cold side extractor and the hot side extractors of chiller/heater assembly 35. This is because certain TECs may perform more efficiently when the hot side of the TEC is maintained at or near ambient temperature. This hot-side temperature can be managed by running heat transfer medium 40 through the cold-side extractor portion of the chiller/heater assembly 35 at a rate much faster than said medium 40 runs through the garment 17. Thus, in this example, the rate adjustment pump 83 moves fluid at a slower rate than does cold fluid pump 45. Other operating conditions for system 10 are described in more detail below.

Additionally, in the example of a cooling application making use of a rate adjustment pump 83, a portion of the faster-flowing heat transfer medium 40 may bypass the rate adjustment pump 83 via an applied stint between outlet 25 and inlet 28, and be cycled back into cold fluid reservoir 47 without flowing through garment 17. The remaining faster-flowing heat transfer medium 40 flows through to the rate adjustment pump 83, is slowed by the rate-adjustment pump, and then is introduced into the garment 17 via outlet 84 at a slower rate than would be possible without a bypass mechanism. The slower-moving heat transfer medium 40 then exits the garment 17 and is returned to case 15 via inlet 85. The slower-moving heat transfer medium 40 is then introduced to cold fluid reservoir 47 where it is again pumped by the faster cold fluid pump 45. In this example, cold fluid reservoir 47 may be constantly cooled since it is receiving bled-off cool heat transfer medium 40 in addition to heated heat transfer medium 40. This may reduce the power required by the chiller/heater assembly 35 to cool the heated heat transfer medium 40.

In the exemplary cooling application depicted in FIG. 3, a second closed-loop system, or closed-loop 2, permits the flow of heat transfer medium 41 between the chiller/heater assembly 35 and the radiator assembly 50. As mentioned above, heat is transferred from heat transfer medium 40 to heat transfer medium 41 in the chiller/heater assembly 35. Heated heat transfer medium 41 then flows from the chiller/heater assembly 35 through bores in case 15 to the radiator assembly 50. As heat transfer medium 41 flows through the radiator assembly 50, heat is transferred from the heated heat transfer medium 41 to air that is introduced to the system 10 as fans 55 pull in ambient air through air inlet 20 and the sealed cowling 60, which may be of a truncated design, into the radiator assembly 50. By truncated design, it is meant that the area of the inlet where air is introduced to case 15 is larger than the area deeper into case 15 where the air is forced through. Thus, the volume of the region where the air is flowing is decreased and the air pressure is correspondingly increased. Other heat transfer mechanisms may be used instead of or in addition to fans 55. This heat transfer thereby cools heat transfer medium 41, and heated air is released to atmosphere. Cooled heat transfer medium 41 then travels to hot fluid reservoir 48. Finally, pump 46 then pumps the cooled heat transfer medium 41 back into chiller/heater assembly 35 so the process can be repeated.

Other methods of removing thermal energy generated by the hot side(s) of the TEC(s) may be used. For example, designs of the radiator assembly 50 are contemplated. One exemplary alternative design may include tubing, which may be made of aluminium or another conducive material. Exemplary dimensions for said tubing may be approximately 2.5 inches square, approximately 6 inches in length, with a wall thickness of approximately 0.125 inch comprising the radiator assembly housing. In such an example, the hot side(s) of the TEC(s) may be mounted to and in contact with the outside of the radiator housing. Thermal energy produced by the hot side(s) of the TEC(s) is radiated to the radiator housing, through to an inner surface(s) of the radiator housing, to which one or more graphite foam blocks may be mounted by any means, including the S-Bonding process. In such an example, the one or more graphite foam blocks may be approximately the same length as the radiator housing. Each graphite foam block may feature a machined pattern such as a saw-toothed pattern along at least part of its longitudinal axis that articulates with the reciprocal pattern machined into the opposing graphite foam block, but leaving a gap between the saw-toothed edges of the graphite foam blocks approximately 0.07 inches through which air may be circulated by means of an air-moving device or devices placed at one or both ends of the radiator housing, thus moving thermal energy from the graphite foam blocks to ambient air. These graphite foam blocks may be machined so as to allow an approximate 0.5 inch gap between the lateral edges of the graphite foam blocks and the remaining unused two inside surfaces of the radiator housing to enhance cooling of the graphite foam blocks by accommodating increased air flow through the inside of the radiator housing. Additional thermal transfer may be accomplished by increasing the surface area of the radiator housing by machining or extruding fluted channels into all unused inner and outer surfaces of the radiator housing. This exemplary structure of the radiator assembly 50 would obviate the need for the hot side extractor(s) 35, heat transfer medium 41 and related tubing, hot fluid pump 46 being replaced by air moving device(s), and hot fluid reservoir 48.

Sensors my be also be used to monitor a variety of conditions, including the temperature of the ambient air, air temperature within the radiator assembly 50, and the temperature of the hot side of the TEC(s) in order to improve system performance electronically. A method of cooling the thermal transfer medium circulating through the liquid cooling garment includes circulating the thermal transfer medium by means of a fluid pump through a heat exchanger that may attached, mechanically or otherwise, to the cold side of the TEC(s).

Efficiency of the TECs may be increased by alternating the on/off cycles of the TECs (toggling) so that one TEC is in stand-by mode while the other is operating. After the operating TEC reaches a peak efficiency, as recorded by a sensor or other mechanism, an electronic switch may switch the operating TEC into stand-by mode while powering up the TEC already in stand-by mode into operating mode. At the same time, an electronically-actuated fluid switch may redirect the flow of the thermal transfer medium to the TEC in operating mode and prevent the flow of thermal transfer media to the TEC in stand-by mode.

Both closed loops 1 and 2 are powered by a power supply box and controlled by a controller or micro processing unit that both may be placed, together or separately, in a receptacle 42 in case 15. Although this illustrative example shows the controller and the power supply box both within case 15, they need not be.

Heat transfer medium 40 and heat transfer medium 41 can be of the same or of a different material. In one exemplary system, heat transfer medium 40 and 41 are non-toxic and environmentally friendly. Heat transfer medium 40 and 41 may be gas or liquid. Heat transfer medium 40 and 41 may include carbon nanotube single-wall or multi-wall (SWNT or MWNT) material in a liquid vehicle such as de-ionized water, isopropyl alcohol, antifreeze or another known or foreseeable thermal transfer material, or combinations thereof. SWNT and MWNT materials are commercially available from Carbon Nanotechnologies Inc. in Houston, Tex. Heat transfer medium 40 and 41 may comprise a thermal conductivity of less than about 1.5 W/mK, or less than about 1.0 W/mK or about 0.8 W/mK. Where SWNT or MWNT materials are used in a liquid vehicle, the concentration of SWNT or MWNT may be less than about 2% by volume, less than about 1% by volume, or about 0.6% by volume.

Pumps 45 and 46 may be designed to snap into or otherwise mechanically fit into case 15 and/or chiller/heater assembly 35 without any tubing or additional attachment mechanisms. Pumps 45 and 46 may be small and lightweight to minimize the burden on persons carrying case 15. Pumps 45 and 46 may weigh less than about twenty (20) grams each (about 0.03 lbs each), or less than about fifteen (15) grams each (about 0.02 lbs each). Pumps 45 and 46 may be of a size of about twenty-eight (28) millimeters (about 1.1 inches) by fourteen (14) millimeters (about 0.55 inches) by fourteen (14) millimeters (about 0.55 inches). Pumps 45 and 46 may be designed to circulate heat transfer medium 40 and 41 at a rate of from about one thousand (1000) milliliters per minute (about sixty (60) cubic inches per minute) to about four thousand (4000) milliliters per minute (about two hundred forty (240) cubic inches per minute). Pumps 45 and 46 may be electric and should use as little power as possible, such as less than about two (2) Watts each, to lengthen the time that the system 10 can run without recharging. Exemplary pumps are commercially available through TCS Micro Pumps, Ltd. of Kent, England.

A rate adjustment pump 83, which may be used in addition to pumps 45 and 56, may be designed to circulate heat transfer medium 40 and 41 at a rate of less than about eight hundred (800) milliliters per minute (about fifty (50) cubic inches per minute) or less than about seven hundred (700) milliliters per minute (about forty-three (43) cubic inches per minute) or about six hundred and fifty (650) milliliters per minute (about forty (40) cubic inches per minute). A rate adjustment pump 83 may be of the same size and shape as pumps 45 and 46, or it may be smaller and/or lighter and/or of a different size or shape. Suitable rate adjustment pumps 83 may be electric and may use about the same amount of power, or less power, than pumps 45 and 46. Suitable rate adjustment pumps are commercially available through TCS Micro Pumps, Ltd. of Kent, England.

Reservoirs 47 and 48 may be built integrally with case 15 as part of the laser-sintering process. Alternatively, reservoirs maybe manufactured separately, and designed to mechanically fit or snap into case 15. Reservoirs 47 and 48 may act as expansion chambers to compensate for temperature and pressure differentials. Reservoirs 47 and 48 may also be used with any known filtering system to minimize or prevent the introduction of fine particulate matter to the system.

Fans 55 may be designed to fit or snap into case 15 without any additional mechanical retaining parts. Fans 55 may be small and lightweight to minimize the weight burden on the user. In one example, each fan 55 weighs less than about fifty (50) grams (about 0.1 lbs) and has a size of about forty (40) millimeters (about 1.6 inches) by forty (40) millimeters (about 1.6 inches) by 28 millimeters (about 1.1 inches). Fans 55 may be electric and should use as little power as possible, to lengthen the time that the system 10 can run without recharging. Each fan 55 may create an air flow of more, than about ten (10) cubic feet per minute (about 280 liters per minute) or more than about twenty (20) cubic feet per minute (about 570 liters per minute) or about twenty-seven (27) cubic feet per minute (about 760 liters per minute). In the example depicted in FIG. 2, fans 55 act together to move about fifty-four (54) cubic feet of air per minute (about 1500 liters per minute) into cowling 60 and ultimately through radiator assembly 50. Suitable fans are commercially available through JARO Thermal of Boca Raton, Fla. Filters may be used in conjunction with fans 55 to prevent particulate material from entering and clogging the system.

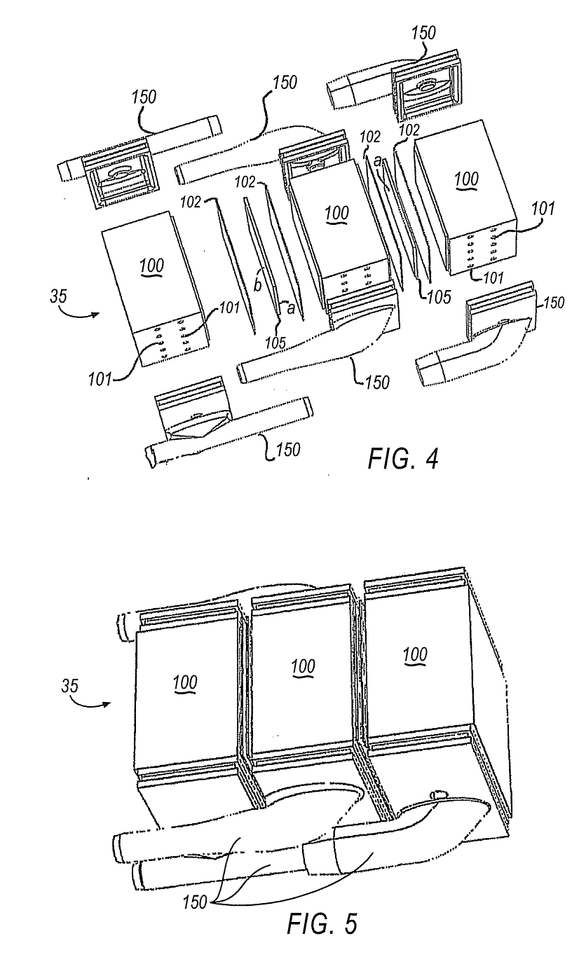

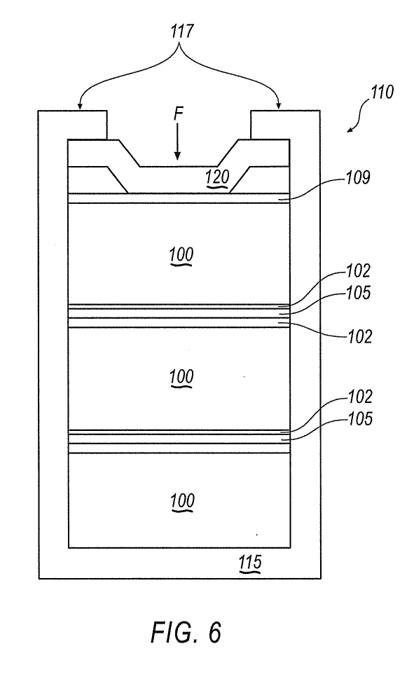

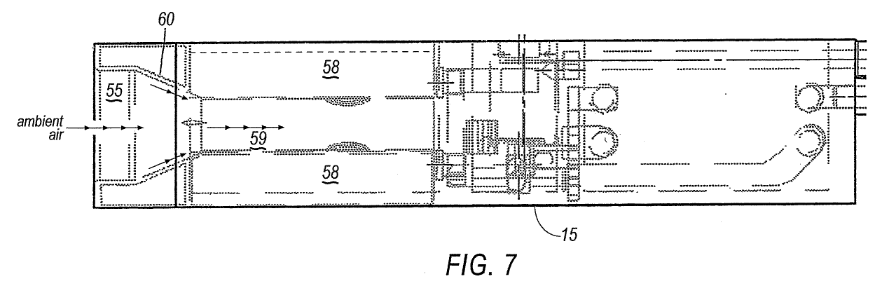

Referring to FIG. 4, an exploded view of an exemplary chiller/heater assembly 35 is shown, as it fits in an exemplary case 15 (shown in FIGS. 1 and 2). In this example, case 15 is integrally formed by laser sintering, including its internal bores and channels (such as bore 26 in FIG. 2) which are adapted to receive extensions 150 so that fluid communication between the integrally formed bores and channels in case 15 and the extensions 150 from chiller/heater assembly 35 does not require tubing. This configuration is merely exemplary; as noted above, configurations wherein channels are added to connect chiller/heater assembly 35 to case 15 for plumbing are contemplated. FIG. 5 depicts a perspective view of the chiller/heater assembly 35. FIG. 6 shows a side view of the chiller/heater assembly 35 of FIG. 4 in a clip assembly 110.

Referring to FIGS. 4-6, a central porous block 100 is depicted, which is part of the flow path of heat transfer medium 40 of closed loop 1. Two end porous blocks 100 are depicted, which are part of the flow path of heat transfer medium 41 of closed loop 2. Thermoelectric devices 105 such as a TEC may be sandwiched (directly or indirectly) between porous blocks 100. As depicted, each thermoelectric device 105 has a surface (a) that is in thermal communication with central porous block 100 through conductive assembly 102. Each thermoelectric device 105 has a surface (b) that is in thermal communication with an end porous block 100 through a conductive assembly 102. Conductive assemblies 102 may be attached to, adhered to, or bonded to porous blocks 100. Conductive assemblies 102 may be held against thermoelectric devices 105 by using a mechanical clip system, a spring-like mechanism, or any other mechanism or means to hold the conductive assemblies 102 sufficiently tightly for high performance thermal communication.

Porous blocks 100 may be made of a highly porous conductive graphite material, thereby having great surface area for heating and/or cooling a heat transfer medium flowing therethrough. Suitable materials may have a compressive strength of from about six hundred (600) psi to about eleven hundred (1100) psi, or from about eight hundred (800) psi to about nine hundred (900) psi. The compressive strength should be sufficient to avoid substantial deformity or crushing when force is applied to hold the chiller/heater assembly 35 together, for example, by a clip assembly 110 in FIG. 6. Thus, suitable materials may be able to withstand a compressive load of, at least, greater than fifty (50) psi. Suitable exemplary materials may be able to withstand a compressive load of about five hundred (500) psi, six hundred (600) psi, or seven hundred (700) psi.

Exemplary materials may have a density of from about 0.5 g/cm³ to about 0.95 g/cm³. Exemplary materials have an in-plane thermal conductivity of less than about 100 W/mK and an out-of-plane thermal conductivity of less than about three hundred (300) W/mK. Exemplary materials may have a specific thermal conductivity (thermal conductivity divided by specific gravity) of greater than three hundred (300) W/mK and up to about seventeen hundred (1700) W/mK. Exemplary materials may have a porosity of from about fifty (50) percent to about seventy (70) percent or from about fifty-five (55) percent to about sixty-five (65) percent. Exemplary materials may have an average pore diameter of about three hundred fifty (350) microns, or less than about five hundred (500) microns, or more than about two hundred (200) microns. Pore diameters and percentage of porosity should be selected to maximize the surface area of material available for heat transfer purposes.

Exemplary materials include carbon foams having a plurality of thermally conductive ligaments. Exemplary materials include the carbon foams described in U.S. Pat. Nos. 6,033,506 and 6,430,935, incorporated by reference herein in their entireties. Exemplary materials include high thermal conductivity (HTC) carbon foams that are commercially available as POCO HTC from Poco Graphite Inc., of Decatur, Tex.

In examples where HTC carbon foams are used for porous blocks 100, a synergistic effect may be realized when heat transfer medium 40 and/or heat transfer medium 41 include carbon nanotube (CNT) material in a liquid vehicle. This may be due to the unique physical manner in which the carbon nanotubes interact with the vast surface area of the porous HTC carbon foams. In particular, CNT material in a fluid carrier absorbs thermal energy in a greater magnitude than does the fluid carrier in the absence of the material. Thus, the presence of the CNT material increases the thermal capacity of a heat transfer medium, making it more efficient. As a result, less heat transfer medium is needed for the same thermal transfer performance if the medium includes CNT material.

Each porous block 100 as depicted has a plurality of channels 101 therein that do not extend from end-to-end. The number and dimensions of channels 101 depend upon the desired flow characteristics for the application: the more channels 101, the faster the flow rate that can be achieved. However, as more channels 101 are added to porous block 100, the surface area of the foam material is reduced which can reduce the effectiveness of porous block 100 for a thermal transfer application. Additionally, if a channel 101 was to extend from one end of porous block 100 to the other, then flow in the direction of the channel might diminish the ability of the heat transfer medium to spread throughout the volume of the foam material to maximize the contact with the surface area of the foam material for thermal transfer purposes.

Two thermoelectric devices 105 are depicted in FIG. 4. Fewer or more thermoelectric devices may be used, depending upon the desired configuration. Thermoelectric devices may include, without limitation, thermoelectric TECs such as those that are commercially available through Tellurex Corporation of Traverse City, Mich. or Marlow Industries of Dallas, Tex. Suitable TECs are described in U.S. Pat. Nos. 5,171,372 and 6,492,585, which are incorporated by reference herein in their entireties. Suitable thermoelectric devices 105 may be substantially flat in shape, and have a hot side and a cold side. Heat is transferred quickly and efficiently from one side of the TEC to the other side of the TEC. A user can control which is the hot side and which is the cold side by reversing the polarity of the TEC by any method, thereby changing which is the hot side of the TEC and which is the cold side of the TEC.

Exemplary thermoelectric devices 105 may be of a shape such that surfaces (a) and (b) are substantially co-extensive in length and width to the surface of the porous blocks 100 between which the devices 105 are (directly or indirectly) sandwiched. In one example, the surfaces (a) and (b) may be smaller than about two (2) inches by two (2) inches, or may be about one and one-half (1.5) inches by one and one-half (1.5) inches. In one example, the surfaces (a) and (b) may be of a ceramic material, including but not limited to aluminium oxide.

Operating conditions for thermoelectric devices 105 can be manipulated to increase efficiency and/or other performance characteristics. Heat or power loads (Q), for example, are one such operating condition. Exemplary thermoelectric devices 105 can handle heat or power loads of up to Qₘₐₓ of about six hundred (600) Watts, and may perforin more optimally when at heat or power loads of less than about four hundred (400) Watts, or from about fifty (50) Watts to about one hundred twenty five (125) Watts, or from about seventy (70) Watts to about one hundred five (105) Watts. The change in temperature (ΔT) from the cold surface (surface (a) for cooling applications) and the hot surface (surface (b) for cooling applications) is another such condition. The polarity of commercially available thermoelectric devices such as TECs is changeable by a user to switch between cooling applications and heating applications.

Exemplary thermoelectric devices 105 may have increased efficiency when (ΔT) is relatively low compared to a ΔTₘₐₓ that can be about seventy (70) degrees C. Relatively low ΔT values are less than about thirty (30) degrees C., or less than about fifteen (15) degrees C., or less than about five (5) degrees C. Marlow Industries has performed power cycling tests on its commercially available TECs with a ΔT of fifteen (15) degrees C. for over two million power cycles without failures, and with a ΔT of thirty (30) degrees C. for over 40,000 power cycles without failures.

Exemplary thermoelectric devices 105 may have increased efficiency when the heat or power load is less than about ⅔ of Qₘₐₓ for a particular device and the ΔT is less than ΔTₘₐₓ. The difference in temperature between the ambient air temperature and the temperature of the hot surface should be relatively low, such as less than about thirty (30) degrees C. or less than about fifteen (15) degrees C. This temperature difference may be minimized when the flow path through the porous blocks 100 is a high performance thermal transfer path, which can be managed by keeping a relatively high flow rate through the porous block 100 that is within closed loop 1.

A conductive assembly 102 is applied to or bonded to porous block 100 to maximize thermal communication between said components. Initial steps may be taken to treat porous block 100 to enhance said thermal communication regardless of the chemical make-up of conductive assembly 102. An initial step may include smoothing or flattening a surface of the porous block 100 to be in direct or indirect communication with a thermoelectric device 105. Smoothing or flattening may be accomplished by machining a surface until it is substantially uniform and substantially flat. In one example, a flat surface on a porous block 100 has a highest peak that is less than or equal to 0.025 millimeters (about 0.001 inch) from its lowest valley. An additional initial step may include cleaning the smoothed or flattened surface to remove particulate matter from the smoothed or flattened surface to maximize exposure of ligaments in the porous block 100 for thermal bonding purposes. Cleaning can be done in any number of ways, including but not limited to blowing filtered compressed air onto the smoothed or flattened surface, then applying a removable adhesive surface (such as cellophane tape) on the smoothed surface or flattened so that the adhesive will adhere to particulates loosened by the compressed air process. The adhesive surface can then be removed from the smoothed or flattened surface without damaging the surface. The process of applying and removing an adhesive surface to the smoothed or flattened substrate may be repeated multiple times.

Additional steps may be taken to apply or bond conductive assembly 102 to porous block 100, depending upon the chemical make-up of one or more conductive materials included in conductive assembly 102. For example, in an instance as depicted in FIG. 4 where a copper sheet is included in conductive assembly 102, a smoothed or flattened surface of porous block 100 may further be metallized by any known method, including but not limited to electroplating methods. Metallizing increases the thermal connection that a later-applied S-Bond alloy may have with, for example, an HTC foam material. Metallization can enhance the thermal transfer properties because, without such treatment, the porous block 100 can expand and contract at different rates than the copper sheet in assembly 102 under the heat transfer conditions in chiller/heater assembly 35; in other words, metallization can mitigate any differences in expansion and/or contraction rates between a copper sheet in assembly 102 and a smoothed or flattened surface on a carbon foam porous block 100. S-Bond alloys that are commercially available from S-Bond Technologies Inc. of Lansdale, Pa. such as S-Bond Alloy 220 or Alloy 400 may be applied to the metallized surface of porous block 100. Suitable alloys may come in the form of pellets, sheets, rods or other forms, and may be applied by the application of heat such as via active solder. S-Bond alloys may provide a semi-flexible surface to minimize or prevent fracture damages to thermally conductive ligaments in the carbon foam porous block 100. In this example, following the application of an S-bond alloy, a copper sheet is then bonded to the S-bond alloy and is in thermal communication with carbon foam porous block 100. Copper plates and sheets are mere exemplary heat-spreading materials that can comprise conductive assembly 102.

In another example, conductive assembly 102 includes or consists of a layer of other heat-spreading materials such as synthetic diamond material or carbon nanotube material (SWNT or MWNT). Such materials may be deposited directly on a smoothed or flattened, cleaned surface of porous block 100 through well known processes including but not limited to chemical vapor deposition (CVD) processes. Suitable diamond materials are described in U.S. Pat. No. 5,783,316, which is incorporated by reference in its entirety. In the case of synthetic diamond material, a very thin layer of powdered synthetic diamond (having an average particle size of less than about thirty (30) microns or less than about twenty (20) microns or about fifteen (15) microns) may be deposited on the smoothed or flattened, cleaned surface to fill in pores on said surface. In particular, a CVD process may be used to apply the diamond material such that the diamond material fuses to the porous block 100, and in particular, fuses to the carbon ligaments within HTC material when such material comprises porous block 100. Such fusing optimizes thermal communication between the diamond material and the porous block 100. Any known CVD process may be used. The material comprising porous block 100 may have different expansion and contraction traits under the high heat intensive environment of, for example, a microwave plasma CVD process. For this reason, a controlled cooling process may be implemented to minimize or prevent de-lamination of CVD diamond from the surface of the foam block 100. In one example, following a CVD process, a porous block 100 with CVD diamond fused thereto was allowed to cool in the CVD reactor under an environment where temperature decrease was controlled. In this example, the reactor temperature was decreased at a rate of less than about five (5) degrees K. per minute until the CVD reactor temperature reached a temperature of about two hundred (200) degrees C. or less. Slow cooling, in this way, minimizes potential for ligaments in an HTC carbon foam material to fracture.

When a diamond material or a carbon nanotube material is used as at least a component of conductive assembly 102, and an HTC carbon foam is used for porous block 100, increased thermal transfer properties may be achieved over those circumstances when only one of (1) HTC carbon foam is used for porous block 100 or (2) a diamond material or carbon nanotube material is included in conductive assembly 102. Thermal conductivities up to about seventeen hundred (1700) W/mK or up to about two thousand (2000) W/mK may be achieved through the HTC carbon foam via ligaments in the HTC foam, and the fusing of diamond material to the HTC carbon foam material and thus to the ligaments therein.

Additional steps may be taken to optimize the surface of conductive assembly 102 that faces a surface (a) or (b) of thermoelectric device 105. One such additional step is to apply a thermal material such as a thermal paste or thermal grease to a surface of conductive assembly 102 to optimize thermal coupling of said surface and a surface (a) or (b) of thermoelectric device 105. Suitable thermal materials may have a thermal resistance of less than about one hundred (100) mm²K/W. Suitable thermal materials may include carbon black dispersions such as those described by U.S. Patent Publications 2005/0016714 and 2006/0246276, incorporated by reference herein in their entireties. Exemplary thermal materials are commercially available from the Shin-Etsu company of Tokyo Japan (including, for example, X23-7783D) and from the Dow Corning Corporation of Midland, Mich. (including for example TC-5022). Other thermal materials with similar heat-transfer properties may also be applied.

Conductive assembly 102 may serve an additional function. Conductive assembly 102 may provide a liquid seal to prevent the flow of heat transfer medium 40 and/or 41 out of porous block 100 and onto thermoelectric devices 105. In such a case, no additional material or materials (which could interfere with and/or impede thermal transfer) would be needed to create a liquid seal on the surface of the foam block 100 where conductive assembly 102 is applied.

Other surfaces of porous blocks 100 that are not covered by conductive assembly 102 and that are not intended to be a part of the flow path of heat transfer media may also employ a liquid seal. Such other surfaces may be ensheathed in an epoxy resin material or in another material or combination of materials capable of adhering or attaching to the porous block 100 and capable of providing a liquid seal via said adherence or attachment. By ensheathing the porous block 100, porous block 100 may also have improved structural integrity. Additionally, the ensheathed porous block 100 may be further insulated from outside air or water temperatures.

The components of chiller/heater assembly 35 may be held against one another in case 15 using any mechanical device sufficient to hold components together that are not chemically bonded, fused or otherwise adhered to one another. In one example depicted in FIG. 6, a clip assembly 110 holds the chiller/heater assembly 35 together. In one exemplary approach, a base clip 115 can be shaped substantially like a U or C, having a base wall and two legs extending therefrom. Notches or other protrusions 117 or other engagement mechanisms may be formed with or attached to the legs for holding a top clip or a retaining clip 120 in place once the components have been added to the base clip 115. Suitable base clips 115 may be formed by laser sintering, injection molding, extrusion, or other well known techniques. Suitable materials for base clips include nylon and theromosetting polymeric materials. A pressure plate 109 is forced against the contents of the base clip 115 by a top clip or a retaining clip 120. A pressure plate 109 can be made of a metal or a rigid, high-strength non metallic material of adequate thickness. The pressure plate 109 may disperse pressure more evenly across a plane to avoid fracturing the materials of porous blocks 100. A top clip or retaining clip can be made of a material capable of providing a spring force, such as a stamped sheet metal spring, that has portions that are removably engageable with the engagement mechanism of the base clip 115.

A first end porous block 100, fused with conductive assembly 102, is inserted into the base clip 115 and is positioned so that the next component inserted into the base clip 115 will contact the conductive assembly 102. Next, a thermoelectric device 105 is inserted into the base clip 115. Then, a central porous block 100 with conductive assemblies 102 fused on opposite surfaces is inserted into the base clip 115 so that one conductive assembly 102 abuts the thermoelectric device 105 in the assembly 110, and the other awaits contact with the next component to be inserted. Another thermoelectric device 105 is inserted into the base clip 115. Finally, a second end porous block 100 is positioned in the base clip 115 with its surface bearing the conductive assembly 102 abutting the thermoelectric device 105. Once all the components are in the base clip 115, the pressure plate 109 can be placed in the base clip 115. Then, retaining clip 120 can be positioned to engage with the base clip 115 and apply a force on the components in the base clip 115. The applied force may be at least fifty (50) psi. The applied force can be up to eighty (80) lbs, up to seventy (70) lbs, or up to fifty (50) lbs. The force should be sufficient to maximize surface contact between thermally conductive surfaces. The better the surface contact between thermally conductive surfaces, the higher the ΔT that the system can achieve.

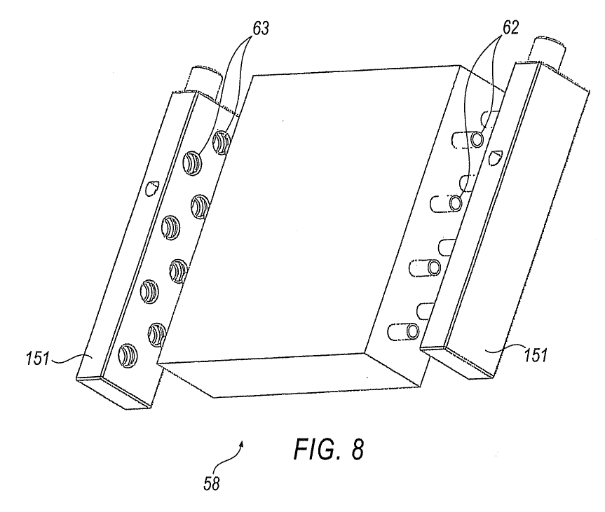

Referring back to FIG. 2, a radiator assembly 50 is shown in case 15. Referring to FIGS. 2 and 7, a side view of radiator assembly 50 is shown having two radiator panels 58. In FIG. 8, a radiator panel 58 is more fully depicted.

FIG. 7 discloses two radiator panels 58 that are substantially parallel with one another. It is contemplated that a radiator assembly could use just one radiator panel 58, or that it could use a plurality of radiator panels 58. The radiators need not be substantially parallel; other configurations of radiator panels 58, including V-shaped configurations, are contemplated for use in radiator assembly 50. The array of radiator panels 58 can increase a cooling capacity of a system 10 without a one-to-one (1:1) corresponding increase in the amount of space required in case 15 to house the radiator assembly 50.

In a cooling example, fans 55 draws ambient air into the case 15. The fans 55 force the air through sealed cowling 60, which is shaped to reduce the volume in which the air can flow before it enters the radiator assembly 50, increasing the pressure of the air in the reduced volume region. The air is pushed outwardly through the material comprising the radiator panels 58, and heat is transferred from heat transfer medium 41 to the air. Warmed air can then be released to atmosphere through any inlet/outlet in case 15. Referring to FIGS. 2, 3, 7 and 8, cooled heat transfer medium 41 exiting the radiator assembly 50 via orifices 63 returns to the reservoir 48, pump 46, into the end porous blocks 100, which are acting as hot side extractors or heat sinks.

FIG. 8 depicts an exemplary radiator panel 58. Radiator panel 58 can be formed from a porous thermally conductive material through which a heat transfer medium, such as air, can flow. The foam material in radiator panel 58 may be the same material or a different material from the foam material of porous block 100. Generally, thermal conductivity of a foam material in radiator panel 58 need not be as high as that of porous block 100. Suitable thermally conductive porous materials for radiator panel 58 may have out-of-plane thermal conductivity of less than about two hundred (200) W/mK or less than about one hundred fifty (150) W/mK or about one hundred thirty five (135) W/mK and an in-plane thermal conductivity of less than about one hundred (100) W/mK or less than about fifty (50) W/mK or about forty-five (45) W/mK. Porosity allows air to travel through the material, and it provides the material with a great amount of surface area for heating/cooling purposes. Increased surface area increases capacity for thermal transfer. Surface area of a suitable material may be as much as about thirty (30) sq.m/cm³, or about twenty-five (25) sq.m/cm³. Total porosity of suitable thermally conductive foams may be less than about ninety (90) percent, less than about eighty (80) percent or about seventy-five (75) percent. Average pore diameter may be less than about 0.025 inches (about 0.64 millimeters), less than about 0.02 inches (about 0.51 millimeters), or about 0.014 inches (about 0.36 millimeters). Density of suitable carbon foams may be less than about 0.75 g/cm³ or less than about 0.60 g/cm³ or about 0.55 g/cm³. Exemplary materials are commercially available as POCOFoam from Poco Graphite Inc., of Decatur, Tex.

FIG. 8 depicts radiator panels 58 having a plurality of channels 62 through which heat transfer medium 41 flows as part of closed-loop 2. Channels 62 engage orifices 63 in channel 151 of panel 58. Channels 151 of panel 58 may engage with integrally formed channels in case 15 (or alternatively, with added channels to connect panel 58 to case 15) to form the closed-loop fluid path 2. Channels 62 may comprise copper or another thermally conductive material placed in thermally conductive material making up radiator panel 58. Alternatively, bores drilled through the thermally conductive material making up radiator panel 58 can be metallized or otherwise treated to be liquid tight and to be conductive so that heat can transfer to/from heat transfer medium 41 to and through the bore and the high-surface area material of panel 58 and, ultimately, the air.

Referring to FIG. 9, a schematic of an exemplary microclimate control system is depicted. FIG. 9 identifies a power source box that may be inserted into a case 15 or in electrical communication with one or more components of case 15. Power to operate the system 10 may be supplied by removable battery packs (e.g., a twelve-volt rechargeable battery) which may optionally be integrated into the lower front and rear portion of a garment 17. This configuration may permit the wearer to change out the battery packs without removing the garment 17 or other equipment. One or more lithium ion polymer type batteries can be used, however different types, materials, and configurations of batteries can be used as determined suitable for the particular application and environment of use. In non-mobile applications, the system can be designed to provide for a plug-in power supply from a wall socket or the like. Power specifications can allow the system to run for approximately four hours between charges. A pulse width modulator can be incorporated into the system to regulate electrical draw on the batteries and conserve power. The battery packs can feature a quick connect/disconnect feature for rapid replacement. The batteries preferably may tolerate a minimum of five hundred (500) to six hundred (600) recharging cycles, and have a recharge time of sixty (60) minutes or less. The system can incorporate a twelve-volt adapter that permits the system to be run off of a twelve-volt power supply while mounted and concurrently charge the system batteries. Photovoltaic cells can also be used to recharge the batteries, and to provide a constant trickle charge when the photovoltaic cells are deployed as the system is being used.

The power supply supports the microprocessing unit or control module. The control module is a micro processing unit that controls the functions and operation of the garment either by manual input on a keypad, automatically from input received by the control module from sensors installed in the vest, or from a remote site which can monitor data output from the control module in real time, then transmit operation commands back to the control module. The control module can be mounted proximate to the left shoulder/arm area. The control module features a keypad that manually controls the system functions (on/off, hot/cold operation, level of heating/cooling). The control module can employ sensors mounted in the vest to monitor ambient air temperature, and also monitor the wearer's body temperature, heart rate, body chloride content and body potassium content. This monitoring can serve multiple purposes. Based on the input from these sensors into the control module, the control module can automatically adjust the output of heat or cold from the chiller/heater mechanism for “hands off” adjustment of temperature for the user. There is also an emergency heat/cold mode built into the control module that will automatically engage if it detects indications of hyperthermia/hypothermia and the wearer is unaware of that condition or unable to manually adjust the output. A USB/RS-232 network module can be built into the control module so that the user's vital signs can be transmitted in real time to a remote site and monitored by medical personnel who can then, in turn, adjust the system operation to regulate the wearer's body temperature, and, if necessary, implement the emergency mode feature if the wearer is unconscious or incapacitated. The control module can incorporate a small screen to display the information input from the sensors.

The heart of the control module is a programmable microprocessor. In the depicted example, there are six inputs for physiological monitoring: three for body temperature, one for heart rate monitoring, one for sweat sodium chloride detection, and one for sweat potassium detection. There can be an input for ambient air temperature monitoring, and another for keypad input. Alternative designs are contemplated having fewer or greater inputs.

The body temperature sensors can be used to monitor the average temperature over the heart area, liver area, and kidney area. It can also measure temperature of extremities (arms/legs) to determine if there is too great a differential between said temperature and a core temperature (heart area). This information can be used to help determine the proper temperature maintenance for the user. If the skin reaches temperatures above or below preset limits, a signal can be sent to the alarm module and/or command center via the network interface.

The heart rate module can monitor heart rate, and if the rate goes above or below preset limits, a signal can be sent to the alarm module and/or command center via the network interface.

The sweat chloride and sweat potassium monitors can help determine the electrolyte balance of the wearer and, in turn, influence the demand on the chiller module. Data outside preset limits can send a signal to the alarm module and/or command center via the network interface.

The alarm module can be a vibrating device similar to the vibrate mode of a cell phone. It can be driven directly by the micro processor when certain sensor value limits are exceeded. A series of coded signals can warn of problems, and actual alarm results can be displayed on the display module.

The display module can be a character readout LCD screen that can reveal all sensor data and alarm results. The screen can be a dark unlit screen for military operations equipment, or can be a lighted screen for civilian equipment or other applications not requiring stealth.

A bidirectional port can be used for a USB/RS-232 network interface. Its function can be to program the microprocessor and/or serve as a communications port to the computer worn by most special operations personnel. Data from the control module can be monitored by command center through the portable computer network. Command center can also override local control if certain conditions are met.

A keypad input allows the wearer to select the temperature that the wearer decides is best for them.

The microprocessor converts the information derived from the inputs and converts it to a pulse width waveform. This waveform can be at the level of the power available and is turned on and off at approximately one-thousand times per second. When there is more demand on the chiller module, the ON pulses become wider; and when there is less demand, the ON pulses become narrower. This waveform can be sent directly to the PowerFET (chiller driver) where the waveform can be amplified to accommodate the high current required to drive the thermoelectric chips in the chiller.

The hot/cold switch can be driven by the microprocessor which can get information through either manual input or can sense temperature differential through the ambient air input and/or from the network interface. The hot/cold switch can electronically switch the voltage to the chiller module to cause the chiller/heater module to heat or cool.

The chiller/heater assembly includes at least one thermoelectric device such as a TEC that produces cold on one side and heat on the other side when a given voltage and current are applied. The hot side requires a means to keep the TEC cool; a finned heat sink with fans can be provided to maintain the temperature within a few degrees of ambient. The cool side requires a means to harvest the lowered temperature; a heat transfer media such as re-circulating water can be used as a heat transfer circulation media. The temperature regulated water can be circulated through the body temperature regulation garment via a low-profile water pump. When the temperature regulated water has circulated through the body temperature regulation garment and performed a cooling or heating function, the water returns to the input side of the chiller/heater to be chilled/heated again.

The fans to cool the hot side of the chiller/heater module and the pump that circulates the water are controlled and driven by the microprocessor.

The hot side of the chiller module can have a temperature sensor that monitors the temperature of the hot side of the TEC devices. If for some reason the hot side gets close to a predetermined temperature (about sixty-five (65) degrees C.) the temperature sensor sends the information back to the microprocessor, and the microprocessor can reduce demand on the chiller driver. If this occurs, a signal can also be sent to the alarm module. This notifies the wearer to take action, if possible.

The cool side of the chiller module can have a temperature sensor that monitors the temperature of the cool side of the TEC device. If the system is in the cooling mode and the cool side gets too cold, freeze up could occur (though highly unlikely) so a signal can be sent back to the microprocessor and the microprocessor reduces the load on the chiller driver.

A fluid-out sensor monitors the temperature of the circulating fluid so the microprocessor can adjust the load on the chiller/heater driver to maintain the selected comfort level. When the temperature goes up, the microprocessor can increase the load on the chiller/heater driver. When the temperature goes down, the microprocessor can decrease the load on the chiller/heater driver.

The warming mode and desired temperature can be selected via the keypad, or, if none is selected, by default. When ambient temperature decreases to about four (4) degrees C., a signal can be sent to the alarm module, and the microprocessor switches automatically and initiates a basic twenty (20) degrees C. heating cycle. These processes can be initiated or overridden by the keypad and/or by command center through a network interface.

When in warming mode, the hot side of the chiller/heater assembly now becomes the cold side, and the cold side now becomes the hot side. The hot and cold side temperature sensors can operate in the same manner to prevent the hot side from becoming too hot, and the cold side from becoming too cold. The fluid sensor can still work to maintain the selected temperature.

The batteries can include built-in chargers, and can accept any DC voltage from ten (10) volts to forty-eight (48) volts DC. The amount of current available will determine how fast the batteries will charge. This wide voltage range makes it easier to use almost any military low-voltage power source to charge the batteries. The batteries are protected from over-voltage charging, over-current charging, and over discharging via electronic monitors built into the battery packs. Historical data can be collected to determine use and abuse. Each battery pack also has a 3.6 volt output to power small appliances—cell phones, radios, iPods, etc. All power output connectors may be electronically and fuse protected.

A power cord from a rated source can be connected directly to a battery input connector while still on the body temperature regulation garment and power the body temperature regulation garment while charging the batteries. The quality of the source will determine how well it will run the body temperature regulation garment and how quickly the batteries will charge.

### Exemplary Uses for Microclimate Control System and Garment

### Military Applications

In addition to being worn by foot soldiers, other military applications of the garment 17 can be worn by crews operating tanks, helicopters, jets or any other mechanized conveyance with an eight to forty-eight volt DC power source. The garment 17 can also be worn by HazMat personnel who wear NBC suits (Nuclear, Biological, and Chemical) in the course of their duties. The garment 17 can also be issued to aircraft crews and boat crews who operate in extremes of temperature as part of their duty/survival equipment. The garment 17 can also be used in logistical or training operations.

### Police, Law Enforcement and Home Land Security

Homeland Security, Navy, Coast Guard, Army National Guard, Marine Corps, Air Force, DEA, Secret Service, Department of Energy, Border Patrol, state, county and local law enforcement agencies may use garment 17. These uses may call for variations to the construction and features of the garment 17 for the specific needs.

### Medical Applications

Medical applications of garment 17 can include MS patients, fever reduction, and hypothermia. The product can also be used in remote areas where heat/air conditioning or any other means of warming/cooling the body are unavailable. Special applications can be designed for use in specific therapeutic treatments (such as knee wraps, elbow wraps, back wraps, etc.). Using certain versions of garment 17, doctors or physical therapists would be able to pre-program therapy to regulate hot and cold treatments and their duration. A different version of the garment can be adapted for use in military surgical centers by field doctors and nurses.

### Sports Applications

The garment 17 can be used by participants involved in auto racing, motorcycle riding, or any form of racing involving a high-heat environment or risk of fire where protective clothing must be worn. Other sports applications include running, biking, golfing (i.e., in southwest United States) or any type of sports physical activity or spectator activity (NASCAR, NT-IRA, Golf Tournaments). Because the garment 17 can also warm the wearer, it can be worn by participants in outdoor winter activities such as hunting, skiing, snowboarding, skating, sledding, ice fishing, etc.

### Commercial Applications

There are several general commercial applications for garment 17, such as use by elderly people living in Florida or Arizona, residents of colder states (Alaska, Minnesota, and Wisconsin) or any individual who wishes to be outdoors but cannot tolerate prolonged periods of exposure to extremes of heat or cold. The garment 17 can be worn by employees of city, county and state governments whose jobs require them to work outdoors (road workers, snow removal, lawn/grounds keepers). Other applications would include both workers and guests at large amusement parks (Disney World, Disneyland, etc.). On especially warm days, these units could be rented, thus allowing the park owners to quickly recoup their investment, and then allowing rental of garments 17 to then become an income stream. Carpenters, roofers, masons, and anyone who works outdoors would benefit from garment 17. Additionally, the garment 17 can prove to be a cost-effective way to save building energy costs by reducing the amount of heating or air conditioning needed to provide a comfortable indoor working environment.

### INDUSTRIAL APPLICATIONS

Industrial applications for body heat reduction benefits to workers can include, by way of example and not limitation the following industries: Foundry Operations/Hot Forging Facilities; Glass Making Facilities; Smelting Operations; Metal Plating Operations; Metal Heat Treating Facilities; Baking, Confectionary and Cooked Food Industries; Petroleum Refineries/Natural Gas Production Facilities; Nuclear Power Facilities; Annealing Operations; Boiler Room Operations; Commercial Aviation (Baggage Handling, Fueling, A&P Mechanics); and/or Road Building/Resurfacing Industry.

The warming feature of the garment 17 would benefit workers, by way of example and not limitation in the following industries: Meat Packing; Snow Skiing Industry; Ice House Operations (Bagged Ice); Snow Removal; Commercial Fishing Industry; High Steel Iron Workers; Commercial Aviation (Baggage Handling, Fueling, A&P Mechanics); and/or Conservation Officers/Park Rangers.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain approaches, or examples, and should in no way be construed so as to limit the claimed invention.

Accordingly, it is to be understood that the above description is intended to be illustrative and not restrictive. Many applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future developments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed:

1. A microclimate system comprising:
a chiller/heater assembly comprising at least two porous members with a thermoelectric device therebetween;
a garment in selective fluid communication with at least one porous member of the chiller/heater assembly to form a first closed loop;
a radiator assembly in selective fluid communication with at least one porous member of the chiller/heater assembly, exclusive of porous members in the first closed loop, in a second closed loop; and
wherein heat is transferable between a first medium in the first closed loop and a second medium in the second closed loop, wherein the first medium and the second medium are the same or different.

2. The system of claim 1 wherein the porous members of the chiller/heater assembly are formed from HTC carbon foam.

3. The system of claim 1 wherein the porous members of the radiator assembly are formed from graphite foam.

3. The system of claim 1 wherein the first medium is selected from the group consisting of water, carbon nanotube (CNT) material dispersed in a liquid vehicle, or air.

4. The system of claim 1 wherein the second medium is selected from the group consisting of water, carbon nanotube (CNT) material dispersed in a liquid vehicle, or air.

5. A method of manufacturing a heating/cooling garment, the method comprising:
providing a garment comprising internal tubing;
installing a microclimate system into a garment by connecting the system to the tubing, the microclimate system comprising:
a chiller/heater assembly comprising at least two porous members with a thermoelectric device therebetween;
connection portals configured for tubing to be in selective fluid communication with at least one porous member of the chiller/heater assembly to form a first closed loop;
a radiator assembly in selective fluid communication with at least one porous member of the chiller/heater assembly, exclusive of porous members in the first closed loop, in a second closed loop; and
wherein heat is transferable between a medium in the first closed loop and a medium in the second closed loop.

6. A method of heating/cooling a garment, the method comprising:
sensing the temperature of a mammal wearing the garment in fluid communication with a microclimate system;
using, at least, the sensed temperature to automatically adjust a microclimate system, the microclimate system comprising:
a chiller/heater assembly comprising at least two porous members with a thermoelectric device therebetween;
connection portals configured for tubing to be in selective fluid communication with at least one porous member of the chiller/heater assembly to form a first closed loop;
a radiator assembly in selective fluid communication with at least one porous member of the chiller/heater assembly, exclusive of porous members in the first closed loop, in a second closed loop; and
wherein heat is transferable between a medium in the first closed loop and a medium in the second closed loop.
